(19) United States
(12) Patent Application Publication
(10) Pub. No.: US 2025/0020488 A1
(43) Pub. Date: Jan. 16, 2025

(54) Assembly for a sensor

(71) Applicant: Balluff GmbH, Neuhausen a.d.F. (DE)

(72) Inventors: Rainer Stark, Neuhausen a.d.F. (DE); Antal Ulrich, Tihany (HU)

(21) Appl. No.: 18/741,054

(22) Filed: Jun. 12, 2024

(30) Foreign Application Priority Data
Jul. 14, 2023 (DE) 102023118760.0

(51) Int. Cl. G01D 5/20

(52) U.S. Cl. CPC G01D 5/2006

(57) ABSTRACT

An assembly for a sensor has a lid (30) which is substantially designed in the shape of a hollow cylinder and is closed at a first end. A coil (20) is arranged at the first end in the lid (30). An insert (10), substantially in the shape of a hollow cylinder, is inserted into the lid (30) so that its first end is facing the coil (20) and its second end protrudes from the lid (30). The insert (10) has at least one latching hook (11) in its interior, which is designed to be spring-loaded orthogonal to the longitudinal axis of the insert (10). The sensor has the assembly and a circuit board (50). The circuit board (50) extends through the second end of the insert (10) into the assembly and is latched with the latching hook (11).

The present invention relates to an assembly for a sensor and to a sensor which has this assembly.

### PRIOR ART

Sensors, such as inductive distance sensors for example, have a coil that functions as a transmitting and/or receiving coil. This is installed in a housing together with an electric circuit board and is electrically connected to the housing by means of a solder connection. For protection from the penetration of moisture, the interior of the housing is filled with a filling material. This may be a polyurethane foam or a casting resin, for example. This material also prevents movements of the circuit board inside the housing in relation to the coil, which could break the solder connection. However, a disadvantage of the use of such foams or resins is that these are environmentally hazardous substances.

Therefore, an object of the present invention is to provide a sensor which functions without the interior thereof being filled with a foam or resin. A further object of the present invention is to provide an assembly, which enables fast and cost-effective mounting of such a sensor.

### DISCLOSURE OF THE INVENTION

This object is solved in a first aspect of the invention by an assembly for a sensor. This assembly comprises a lid which is substantially designed in the shape of a hollow cylinder, preferably in the shape of a hollow circular cylinder. The lid has a first end and a second end and is closed at the first end. A coil is arranged at the first end in the lid. This coil can be arranged in particular on or in a carrier material. In particular, it is designed as a print coil. Furthermore, the coil can be arranged, in particular together with one or more additional coils, on or in the carrier material. The coil can be designed as a transmitting coil, as a receiving coil or as a transmitting and receiving coil. Furthermore, the assembly comprises an insert substantially in the shape of a hollow cylinder, which is preferably in the shape of a hollow circular cylinder. This has a first end and a second end. It is inserted into the lid in such a way that its first end is facing the coil and its second end protrudes from the lid. The insert has at least one, preferably two, latching hooks in its interior. Each latching hook is designed to be spring-loaded orthogonal to the longitudinal axis of the insert.

The latching hook enables a circuit board to be fixed in a defined position in the assembly. When it engages into a cavity of the circuit board, this is held positionally fixed in the assembly, without a foam or resin being required as a filling material, in order to prevent subsequent position changes of the circuit board in relation to the assembly and thus the coil. Furthermore, designing the lid, the coil and the insert in a common assembly has the advantage that this can be used as a stocked pre-assembly group for subsequent fast and flexible final assembly of different sensor types. Subsequently, the sensor type is thus determined by the type of circuit board which is inserted into the assembly and is connected to the coil.

It is preferable that the insert has at least three partial regions in its region arranged in the lid. A first partial region borders a second partial region, the second partial region borders a third partial region, and the third partial region borders the second end of the lid and, if necessary, extends beyond this. An external diameter of the first partial region is larger than an external diameter of the second partial region. The external diameter of the second partial region is larger than an external diameter of the third partial region. This means that the external diameters of the partial regions become larger from the open, second end of the lid in the direction of its closed, first end.

This embodiment of the partial regions can advantageously be used for fixing the insert in the lid. For this purpose, an intermediate space between an internal wall of the lid and the second partial region and the third partial region of the insert is preferably filled with an adhesive. In this case, due to its relatively large distance from the internal wall of the lid, the third partial region can be used as a dispensing chamber for the adhesive. In the second partial region, in which the distance between the internal wall of the lid and the external wall of the insert is smaller than in the third partial region, adhesive bonding takes place between the insert and the lid by using a small volume of adhesive. The first partial region is in particular so close to the internal wall of the lid that it functions as an adhesive brake and prevents adhesive, which was dispensed in the third partial region, from spreading out beyond the third partial region and the second partial region.

Furthermore, it is preferable that the insert has a fourth partial region outside the lid. The external diameter of the fourth partial region is smaller than the external diameter of the third partial region. A first seal is arranged on an outer side of the fourth partial region. This is particularly preferably designed as an O-ring encircling the fourth partial region. If the assembly is guided into a sensor housing, the first seal prevents moisture which creeps between the lid and the internal wall of the sensor housing from being able to spread out further on this end of the sensor housing into the interior of the sensor housing. Penetration of the moisture into the lid is prevented by the adhesive. This ensures that the sensor is sealed to liquid and gaseous media without the need to fill the interior of the sensor housing with a foam or resin. In this manner, a sensor can be obtained which complies with protection class IP68 according to the standard ISO 20653.

During final assembly of the sensor, its circuit board should be positioned in a defined position in relation to the coil. In order to achieve this, it is preferably provided that the insert has a first positioning element in the form of a projection which engages with the coil. In particular, it engages into a cavity of a carrier material of the coil. In this manner, the coil is positioned in a defined position relative to the insert. Furthermore, it is preferably provided that the insert has a second positioning element in the form of a track. This track is set up to receive a circuit board pushed through the second end of the insert. In this manner, the circuit board is also positioned in a defined position relative to the insert. Due to the fixing of the coil relative to the insert and the fixing of the circuit board relative to the insert, a defined relative position of the circuit board relative to the coil can be achieved.

In principle, there is still the possibility of incorrectly positioning the circuit board by rotating it 180° relative to its intended position. In order to exclude this risk, it is further preferable that the insert has a third positioning element at its second end. This is set up to align a light source of the circuit board. Circuit boards used in sensors often have a light source on one side, for example in the form of an LED. The third positioning element, which is designed for example as a cavity in the insert, can serve as an optical positioning aid, in order to ensure that the correct orientation is selected from the two possible orientations of the circuit board in the track. In this manner, incorrect positioning is excluded.

In a further aspect of the invention, the object is achieved by a sensor, in particular by an inductive sensor, which comprises the assembly. Furthermore, the sensor comprises a circuit board. This extends through the second end of the insert into the assembly and is latched with the latching hook. For this purpose, the circuit board has in particular a cavity into which the latching hook engages. The circuit board is fixed stationary in the sensor relative to the assembly and thus relative to the coil.

It is preferable that the sensor has at least one spring-loaded element which electrically contacts the coil and the circuit board. In this manner, the circuit board and the coil are electrically connected with each other, without the need for a solder connection. The spring-loaded element can be arranged either on the circuit board or on the coil, in different embodiments of the sensor. It is arranged in particular by means of SMT (surface-mount technology). If the circuit board is inserted during the final assembly of the sensor into the insert of the assembly, the circuit board and the coil converge so that either the spring-loaded element arranged on the circuit board comes into contact with the coil or the spring-loaded element arranged on the coil comes into contact with the circuit board. In the process, it is deflected, partially overcoming its spring force, so that it lies firmly against the circuit board or the coil and establishes a secure electrical connection between the circuit board and the coil.

Embodiments of the spring-loaded element that are particularly suitable for the sensor are selected from the group consisting of a spring contact, an edge connector and a cable clamp.

A spring contact can be formed differently for this purpose in different embodiments. For example, it can be folded over one time or several times. In embodiments in which the spring contact is arranged on the circuit board, its contact point with the coil can be in the plane of the circuit board or also above the plane of the circuit board. It can extend from the end of the circuit board facing the coil in the direction of the coil or also initially run above the circuit board before contacting the coil. It is also possible for the spring contact to embrace the circuit board by being arranged on one side of the circuit board, projecting from the latter in the direction of the coil up to a point at which it contacts the coil and extending further from there to the opposite side of the circuit board.

If the spring-loaded element is designed as an edge connector, it is arranged in particular on a carrier material of the coil so that the end of the circuit board can be pushed into the edge connector.

If the spring-loaded element is designed as a cable clamp, which can also be referred to as a cable clip, it is arranged in particular on a carrier material of the coil. It can contact the circuit board pushed into the cable clamp simultaneously from its top side and from its bottom side and establish an electrical connection to said circuit board in the area of a surface metallic coating on the circuit board.

The assembly and the circuit board are preferably arranged in an in particular cylindrical housing. The assembly thus closes one end of the housing. A tube closure is arranged on a second end of the housing in the housing. The tube closure has a plug insert which is electrically connected with the circuit board. A second seal is arranged between the tube closure and an internal wall of the housing. This is preferably designed as an O-ring. In this manner, the end of the housing opposite the assembly can also be sealed reliably against the ingress of fluids. Therefore, it is not necessary to fill the interior of the housing with a foam or resin. Instead, it is preferable that the circuit board is surrounded by a gas, in particular by air.

### BRIEF DESCRIPTION OF THE DRAWINGS

Exemplary embodiments of the invention are represented in the drawings and are explained in more detail in the following description.

FIG. 1a shows an isometric representation of an insert of a sensor according to an exemplary embodiment of the invention.

FIG. 1b shows another isometric representation of the insert according to FIG. 1a.

FIG. 1c shows a further isometric representation of the insert according to FIG. 1a.

FIG. 1d shows a sectioned isometric representation of the insert according to FIG. 1a.

FIG. 2 shows a sectional representation of an assembly of a sensor according to an exemplary embodiment of the invention.

FIG. 3 shows a sectional representation of an insert and an adhesive, arranged therein, of the assembly according to FIG. 2.

FIG. 4 shows an isometric representation of a coil in an exemplary embodiment of the sensor according to the invention.

FIG. 5 shows a sectional representation of a sensor according to an exemplary embodiment of the invention.

FIG. 6 shows, in an isometric sectional representation, how a circuit board is introduced into an insert in an exemplary embodiment of the sensor according to the invention.

FIG. 7 shows, in an isometric sectional representation, the arrangement of a circuit board in an assembly of a sensor according to an exemplary embodiment of the invention.

FIG. 8a shows an isometric representation of a spring contact of a sensor according to an exemplary embodiment of the invention.

FIG. 8b shows an isometric representation of another spring contact of a sensor according to an exemplary embodiment of the invention.

FIG. 8c shows an isometric representation of yet another spring contact of a sensor according to an exemplary embodiment of the invention.

FIG. 8d shows an isometric representation of yet another spring contact of a sensor according to an exemplary embodiment of the invention.

FIG. 8e shows an isometric representation of yet another spring contact of a sensor according to an exemplary embodiment of the invention.

FIG. 8f shows an isometric representation of yet another spring contact of a sensor according to an exemplary embodiment of the invention.

FIG. 8g shows an isometric representation of yet another spring contact of a sensor according to an exemplary embodiment of the invention.

FIG. 9 shows an isometric representation of an edge connector of a sensor according to an exemplary embodiment of the invention.

FIG. 10 shows an isometric representation of a cable clamp of a sensor according to an exemplary embodiment of the invention.

FIG. 11 shows, in a side view, how a circuit board is arranged in a cable clamp in a sensor according to an exemplary embodiment of the invention.

FIG. 12 shows, in an isometric sectional representation, the arrangement of a circuit board in an assembly according to an exemplary embodiment of the invention.

### EXEMPLARY EMBODIMENTS OF THE INVENTION

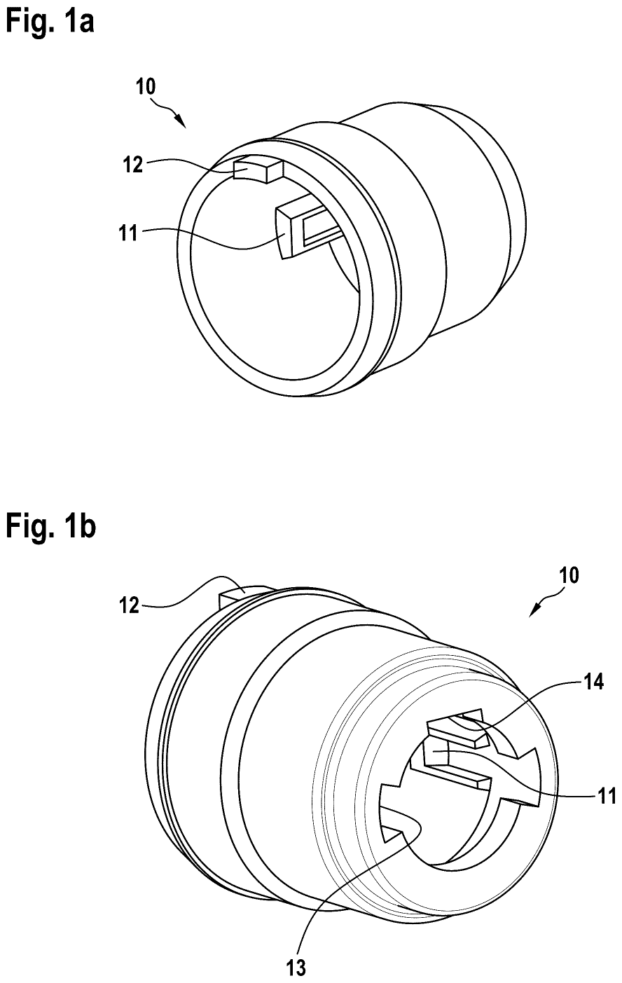

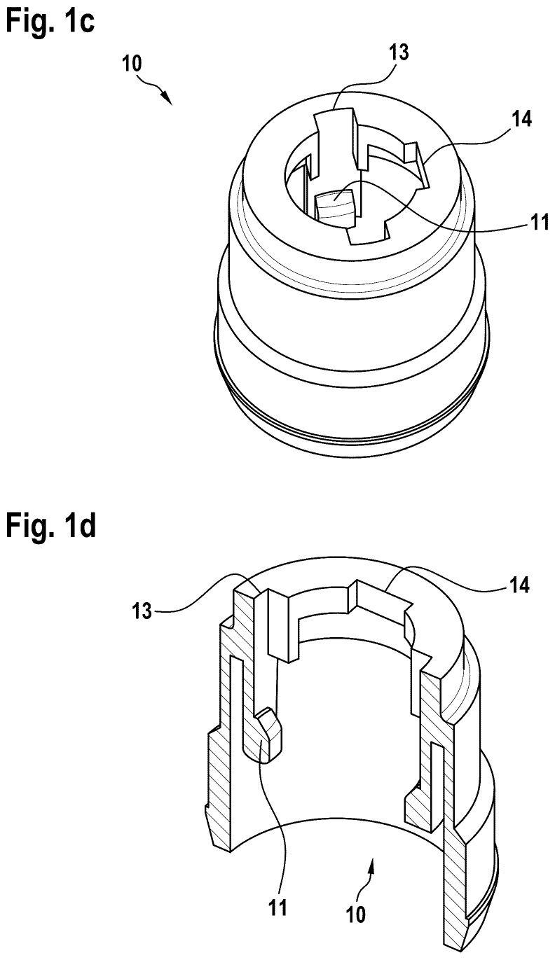

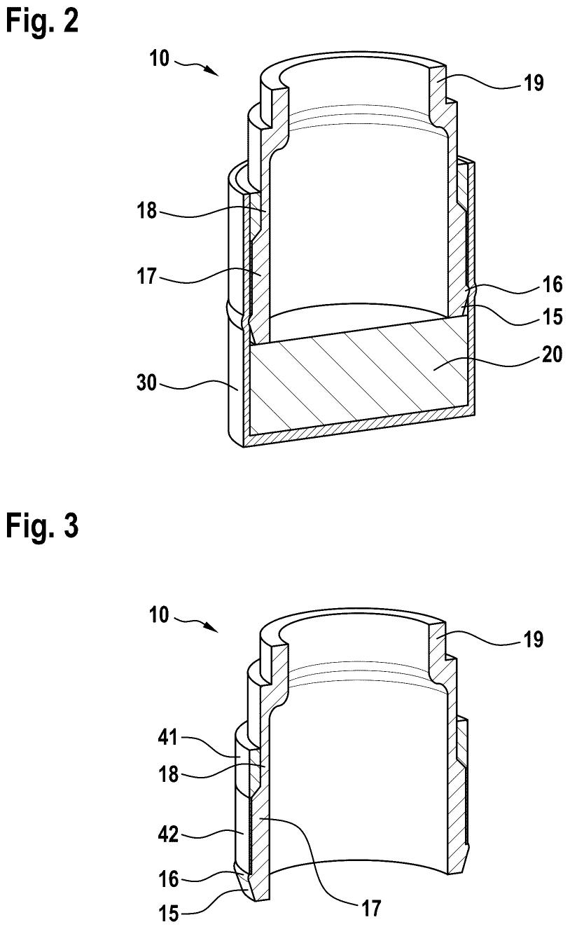

To manufacture a sensor according to an exemplary embodiment of the invention, which is designed for example as an inductive sensor, initially an assembly is produced which serves as a pre-assembly group for the later final assembly of the sensor. This assembly has an insert 10 which is represented in FIGS. 1a to 1d. The insert 10 is designed substantially in the shape of a hollow circular cylinder. It has two latching hooks 11 in its interior, which are integral with the insert. The latching hooks 11 are designed to be spring-loaded orthogonal to the longitudinal axis of the insert 10. The insert 10 has a first positioning element 12 at a first end in the form of a projection. The opening of the hollow cylinder is narrowed at its opposite, second end, wherein a second positioning element 13 is formed in the narrowing in the form of a track. Looking at the insert 10 from its second end, it has a circular opening which is enlarged at two opposing points by the second positioning element. If a plane is laid through this track, the two latching hooks 11 also lie in the plane. The circular opening is further widened by a third positioning element 14. This widening is orthogonal to the plane.

Along with the insert 10, the assembly has a coil 20 and a lid 30. The insert 10 consists of a plastic. The coil 20 is designed as a print coil in a circuit board substrate. This has a circular cross-section. Similarly, the lid 30 consists of a plastic. It has a substantially circular cylinder-shaped outer contour and is closed at one end, its first end. The coil 20 is inserted into the lid 30 in such a way that it contacts the closure of the first end. The insert 10 is inserted into the lid 30 in such a way that that it is mounted on the coil 20 and partially protrudes from the lid 30. The insert 10 has four sections 15-19 with different external diameters. A base section 15 contacts the coil 20. This borders a first section 16 which has the largest external diameter of all the sections. Additionally, this engages into a ring-shaped circumferential cavity in the lid 30 and fixes the insert 10 in its position. A second section 17, a third section 18 and a fourth section 19 follow the first section 16. The external diameter of these sections decreases from the first section 16 to the fourth section 19. The base section 15, the first section 16 and the second section 17 are arranged completely in the lid 30. The third section 18 is arranged partially inside and partially outside the lid 30. The fourth section 19 is arranged completely outside the lid 30.

In order to permanently connect the insert 10 to the lid 30, an adhesive is filled into the lid 30, through the intermediate space between the internal wall of the lid 30 and the external wall of the insert 10. As shown in FIG. 3, it thus initially fills the space between the lid 30 and the second section 18, which functions as a dispensing chamber and for example can have a volume of 22.7 mm³. Under this area of the adhesive 41, it flows further into the intermediate space between the cap 30 and the first section 17. A smaller volume of, for example, 4.8 mm³ is now filled with adhesive 42 and a firm bond is achieved between the insert 10 and the cap 30. Finally, the first section 16 functions as an adhesive brake and prevents the adhesive 41, 42 from flowing deeper into the lid 30.

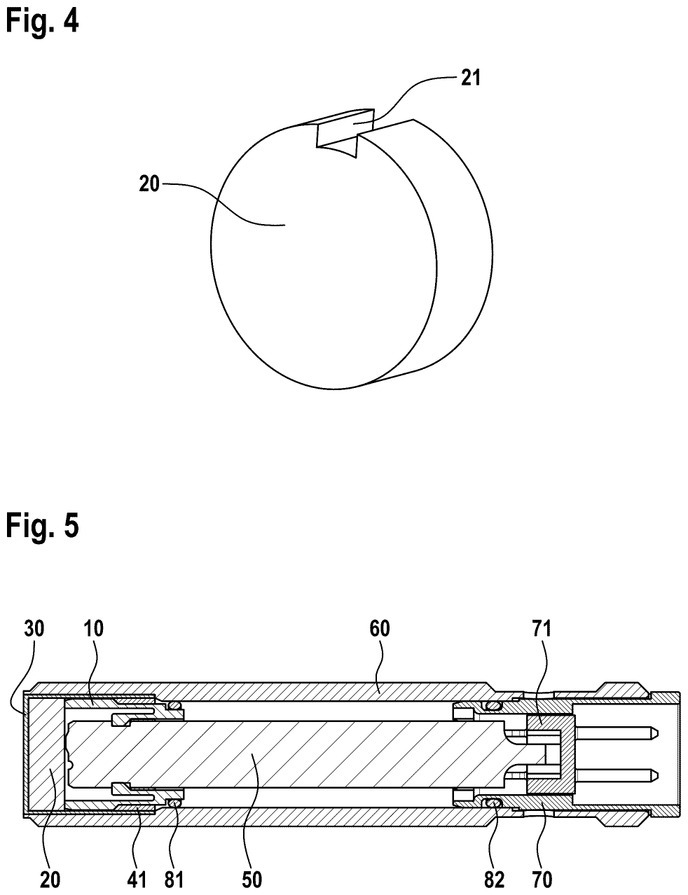

FIG. 4 shows that the circuit board substrate of the coil 20 has a cavity 21 on its lateral surface. The first positioning element 12 of the insert 10 engages into this cavity 21, so that the coil 20 is positioned in the lid 30 in a defined position relative to the insert 10.

FIG. 5 shows a representation of a fully mounted sensor according to an exemplary embodiment of the invention. A circuit board 50 was pushed into the assembly, which consists of the insert 10, the coil 20 and the lid 30. The assembly and the circuit board 50 were arranged together in a circular cylinder-shaped housing 60, which consists of a plastic for example, in such a way that the lid 30 closes the housing 60 at one end. A tube closure 70 was introduced from the other end of the housing 60 into the housing 60 in such a way that it closes the housing 60 at its other end. A plug insert 71 which electrically contacts the circuit board 50 is arranged in the tube closure. The circuit board 50 of the sensor can be connected with external devices by means of plug contacts of the plug insert 71. The sensor has a first seal 81 and a second seal 82 which are each designed as an O-ring. The first seal 81 runs around the fourth section 19 of the insert 10, so that this section 19 functions as a collar for the first seal 81. The second seal 82 runs around the tube closure 70. The two seals 81, 82 close the interior of the housing 60 in a fluid-tight manner. This interior is filled with air.

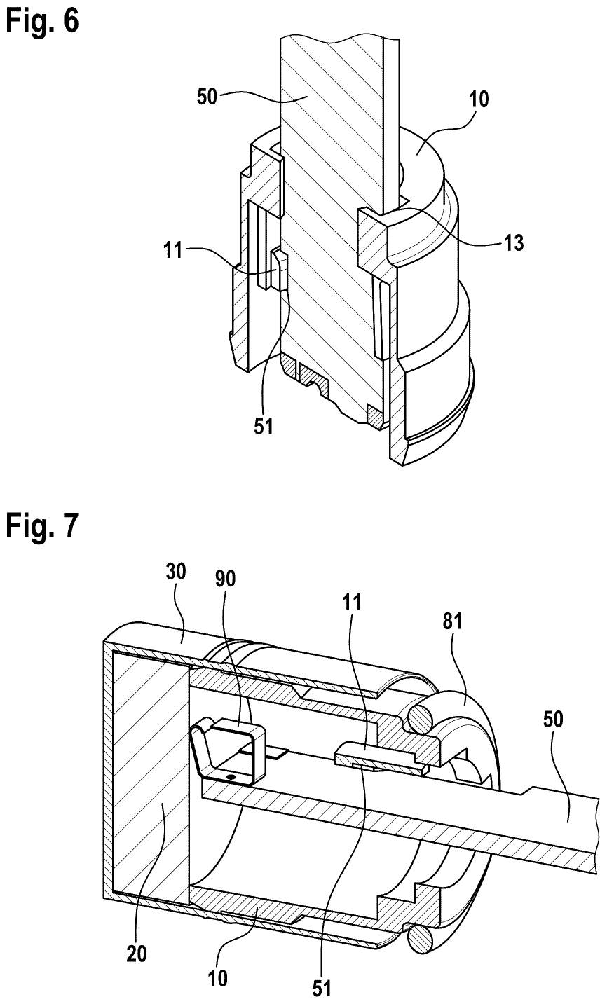

FIG. 6 shows how the circuit board 50 is inserted into the insert 10. It was inserted into the insert 10 from the end of the assembly facing away from the coil 20 through the track 13, until the two latching hooks 11 of the insert 10 engaged in two cavities at the edges of the circuit board 50, so that the latter cannot be moved further forwards or backwards. On the side of the circuit board not visible in FIG. 6, a light source in the form of an LED is arranged, which protrudes from that surface of the circuit board 50. The circuit board 50 was inserted into the insert 10 in such a way that the third positioning element 14 is located on the same side of the circuit board 50 as the light source. The LED can radiate light through a window (not shown) in the housing 60 of the sensor in the vicinity thereof and output information about the function of the sensor.

FIG. 7 shows that a spring-loaded element in the form of a spring contact 90 is arranged on the circuit board 50, at the end of the circuit board 50 which is facing towards the coil 20. This spring-loaded element is pressed against the coil 20 when the circuit board 50 is inserted into the assembly and produces an electric connection between the circuit board 50 and the coil 20.

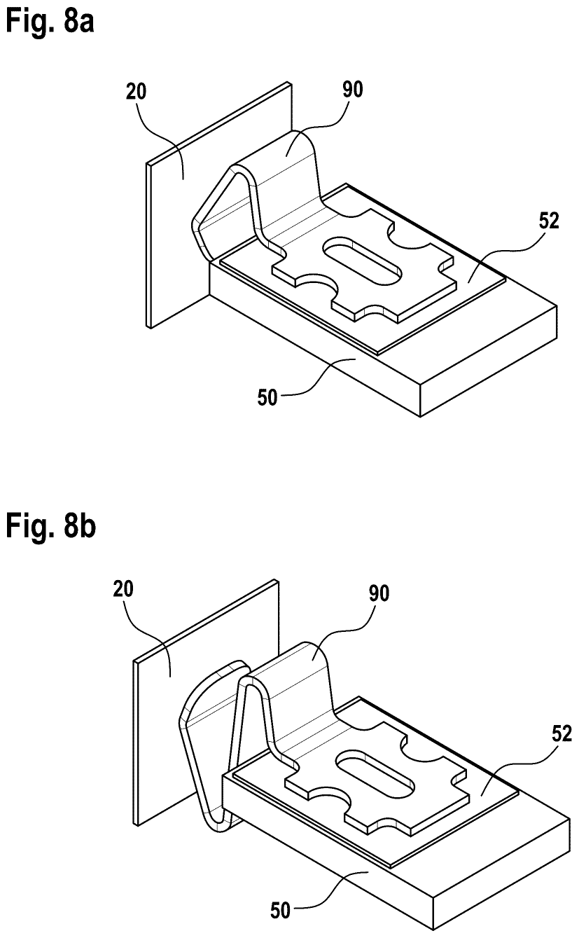

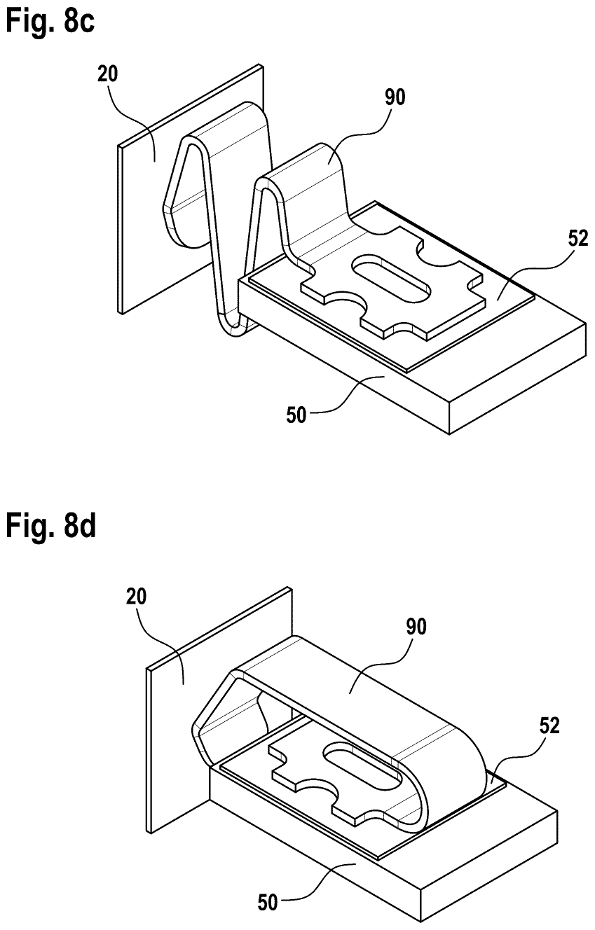

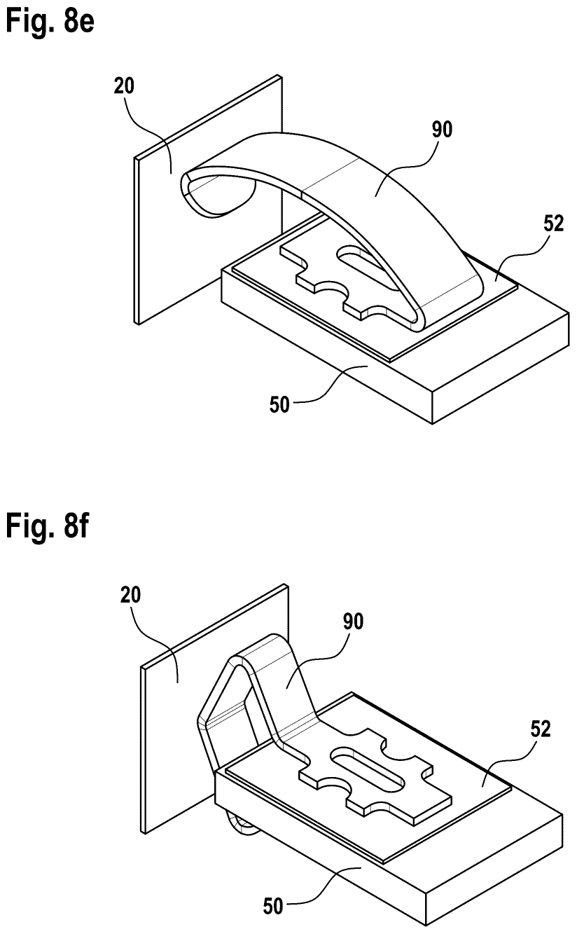

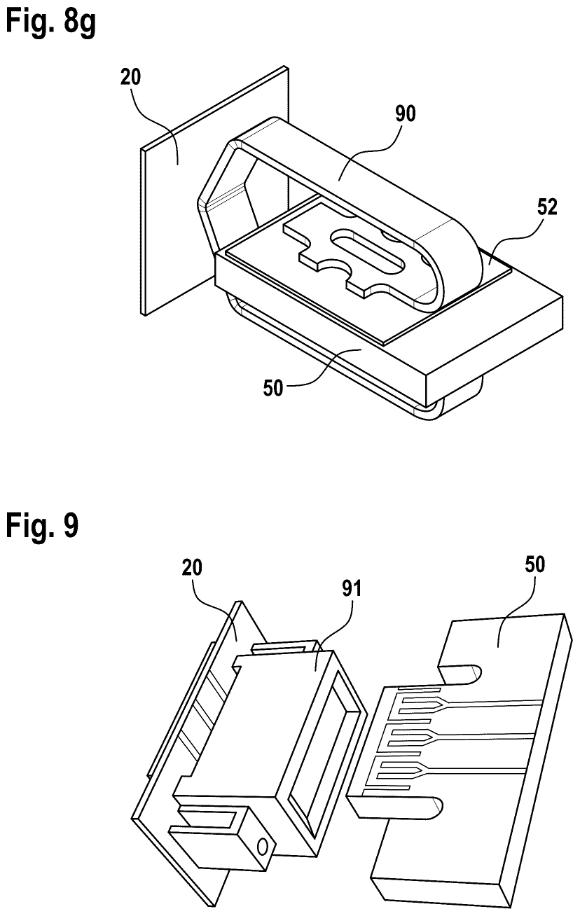

In FIGS. 8a to 8g, different embodiments of the spring contact 90 are represented. This is arranged in each case on a metallic coating 52 of the circuit board 50 and contacts the coil 20. According to FIG. 8a, the spring-loaded element is designed as a spring contact 90, which is bent three times and projects from the end of the circuit board 50 in the direction of the coil 20. By contrast, according to FIG. 8b, the spring contact 90 is bent four times. According to FIG. 8c, it is even bent five times. According to FIG. 8d, the spring contact 90 initially projects from the circuit board 50 counter to the direction of the coil 20, it is then bent so that it extends parallel to the circuit board 50 towards the coil 20 and is finally bent two more times in order to contact the coil 20 in the plane of the circuit board 50. According to FIG. 8e, in a similar configuration, the coil 20 is contacted above the plane of the circuit board 50. According to FIG. 8f, a spring contact 90, bent four times, extends from the end of the circuit board 50 towards the coil 20 and also engages around the circuit board 50. According to FIG. 8g, initially the spring contact 90 extends away from the coil 20, then runs parallel to the circuit board 50 towards the coil 20 and is subsequently bent multiple times in order to contact the coil in this manner on the one hand and to engage around the circuit board 50 on the other hand, and to run away again from the coil 20 under the metallic coating 52 parallel to the circuit board 50.

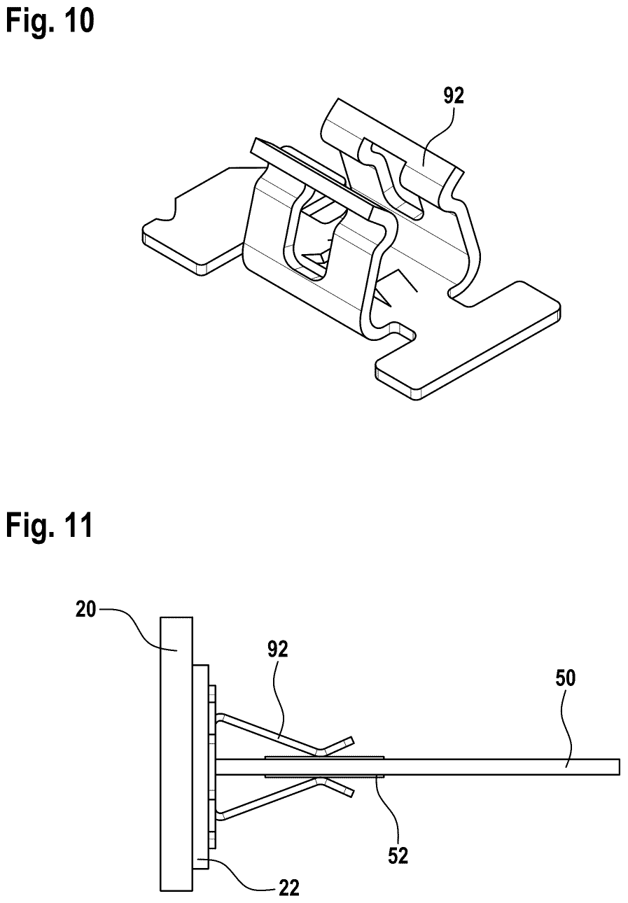

FIG. 9 shows an exemplary embodiment in which a spring-loaded element is not arranged on the circuit board 50 but instead on the circuit board substrate of the coil 20. It is designed as an edge connector 91. When pushing the circuit board 50 into the assembly, the edge of the circuit board 50 is introduced into the edge connector 91.

In a further exemplary embodiment, a spring-loaded element is provided which is designed as a cable clamp 92. As is shown in FIG. 11, this is arranged on the surface of the circuit board substrate of the coil 20. The circuit board 50 has a metallic coating 52 on both its top side and bottom side. It is pushed into the cable clamp 92 in such a way that this contacts both metallic coatings 52.

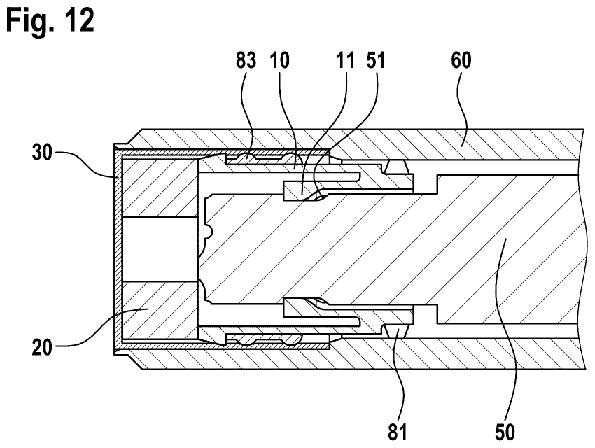

A further exemplary embodiment of the sensor, which is shown in FIG. 12, differs from the exemplary embodiment according to FIG. 5 in that the insert 10 is not adhesively bonded into the lid 30. Instead, a third seal 83 is provided which runs around the insert 10 and is arranged between this and the lid 30. Both the first seal 81 as well as the third seal 83 are injection moulded onto the insert 10 in this exemplary embodiment of the sensor. The insert 10 is secured in the lid 30 by the third seal 83 and by pressing the first region 16 of the insert 10 with the lid 30.

1. Assembly for a sensor, the assembly comprising:
a lid substantially designed in a shape of a hollow cylinder and closed at a first end,
a coil arranged at the first end in the lid, and
an insert substantially in a shape of a hollow cylinder inserted into the lid in such a way that a first end of the insert is facing the coil and a second end of the insert protrudes from the lid, wherein the insert has at least one latching hook located interiorly designed to be spring-loaded orthogonal to a longitudinal axis of the insert.

2. Assembly according to claim 1, wherein the insert has at least three partial regions in it's region arranged in the lid, wherein a first partial region borders a second partial region, the second partial region borders a third partial region and the third partial region borders the second end of the lid, and wherein an external diameter of the first partial region is larger than an external diameter of the second partial region and the external diameter of the second partial region is larger than an external diameter of the third partial region.

3. Assembly according to claim 2, wherein an intermediate space between an interior wall of the lid and the second partial region and the third partial region of the insert is filled with an adhesive.

4. Assembly according to claim 2, wherein the insert has a fourth partial region outside the lid, the external diameter of which fourth partial region is smaller than the external diameter of the third partial region, wherein a first seal is arranged on an outer side of the fourth partial region.

5. Assembly according to claim 1, wherein the insert has a first positioning element in the form of a projection which engages with the coil, and has a second positioning element in the form of a track which is set up to receive a circuit board pushed through the second end of the insert.

6. Assembly according to claim 5, wherein the insert has a third positioning element at a second end, which is set up to align a light source of the circuit board.

7. A sensor, comprising;
an assembly comprising a lid substantially configured in a shape of a hollow cylinder and closed at a first end; a coil arranged at a first end in the lid, and an insert substantially in a shape of a hollow cylinder inserted into the lid in such a way that a first end of the insert faces the coil and a second end of the insert protrudes from the lid, wherein the insert has at least one latching hook located in the interior thereof configured to be spring-loaded orthogonal to a longitudinal axis of the insert; and;
a circuit board which extends through the second end of the insert into the assembly and latched with the latching hook.

8. The sensor according to claim 7, having at least one spring-loaded element which electrically contacts the coil and the circuit board.

9. The sensor according to claim 8, wherein the spring-loaded element is selected from the group consisting of a spring contact, an edge connector and a cable clamp.

10. The sensor according to claim 7, wherein the assembly and the circuit board being arranged in a housing, wherein a tube closure, which has a plug insert, being arranged on one end of the circuit board in the housing, and a second seal being arranged between the tube closure and an interior wall of the housing.

11. The sensor according to claim 10, wherein the circuit board is surrounded by a gas.
